(19) United States
(12) Patent Application Publication
(10) Pub. No.: US 2008/0246738 A1
(43) Pub. Date: Oct. 9, 2008

(54) System and Method for Projecting Control Graphics

(75) Inventors: Corey Bischoff, Cincinnati, OH (US); Gary Grimes, Roswell, GA (US); Tom Collins, Cincinnati, OH (US); Ed Stamm, Roswell, GA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,179

(22) PCT Filed: Apr. 28, 2006
(86) PCT No.: PCT/IB2006/051332

§ 371 Date: Jun. 9, 2008

Related U.S. Application Data
(60) Provisional application No. 60/677,460, filed on May 4, 2005.

(51) Int. Cl. G06F 3/041

(52) U.S. Cl. 345/173

(57) ABSTRACT

Systems and methods for projecting graphics onto a surface are provided. According to exemplary embodiments, systems and methods for projecting control graphics onto a surface that includes control functionality are provided. The surface may take the form of a control panel, touch panel or the like. The control panel is typically operatively connected to various components and/or systems, and is typically adapted to control various operations and/or functionalities. The control graphics are generally projected onto the surface, e.g., the control panel or touch panel, in response to a stimulus, e.g., user interaction. In exemplary embodiments, the stimulus/user interaction may take the form of voice command, user proximity (e.g., to a sensor), or the like. Graphic projection onto the surface may vary in intensity (e.g., over a range of dim to bright), and may be undetectable (e.g., non-existent) in the absence of the requisite stimulus. In further exemplary embodiments, information (e.g., programming reminders) or images (e.g., decorative images) may be projected onto the surface in place of control graphics, e.g., in the absence of the requisite stimulus.

### TECHNICAL FIELD

The present disclosure is directed to a system and method for projecting graphics onto a surface and, more particularly, to a system and method for projecting control graphics onto a surface that includes control functionality, e.g., a control panel and/or touch panel.

### BACKGROUND ART

Electronic components have become prevalent in all aspects of modern life. In many instances, electronic components are designed to respond to user input. In this regard, it is common for electronic components to include control functionality that is responsive to user interaction, e.g., by way of a control panel, remote control unit, graphical user interface (GUI) or the like. In circumstances where user interaction is supported by a control panel, it is no uncommon for the control panel to take the form of a touch screen or similar construct/mechanism. It is also not uncommon for control panels to include graphical information, e.g., verbiage and/or icons/symbols, to facilitate user interaction therewith.

Television units and computer systems are exemplary of types of electronic components that are generally adapted to respond to user input and/or user interaction. In various applications, a control panel and/or touch screen is adapted to facilitate user interaction with such television/computer system. Typically, the control panel and/or touch screen includes graphical information regarding the nature of individual control elements of the control panel/touch screen. For example, in the case of a television unit, a first control element may be adapted to control “volume,” a second control element may be adapted to control “channel,” a third control element may be adapted to control “input,” and so on. Similarly, in the case of other electronic components, graphical information, e.g., verbiage and/or icons/symbols, are typically provided to facilitate interaction therewith.

For a variety of reasons, it may be undesirable to include graphical information in close association with control element(s) that support user interaction. For example, the graphical information may be generally unsightly and/or detract from the desired visual impact/appearance of the electronic component. In addition, the graphical information may be unnecessary at points of time and, in certain instances, for prolonged periods of time. Thus, in the case of television control features and based on the prevalent use of remote control technology, a viewer is rarely called upon to directly interact with control elements positioned on the console itself. Moreover, the inclusion of graphical information impacts on the spatial design/layout of electronic components as designers/manufacturers must accommodate the printing, adhering or other positioning of verbiage/icons/symbols at an appropriate location relative to individual control elements.

U.S. Patent Publication No. 2003/0025676 to Cappendijk describes a dynamic graphical user interface specific to touch screen panels. The graphical user interface includes a window for showing information content and a graphical menu comprising touch-selectable elements, such as icons or buttons. The graphical user interface is designed so that the graphical menu is displayed when sensing means detects a presence in the vicinity of the panel. The display of the menu causes a modification of the showing of the information content. The menu may cause the window to be reduced or the menu may overlap the window. After a predetermined elapsed period of time, the menu is hidden again and the window restored.

U.S. Patent Publication No. 2003/0092470 to Kurakane discloses a cellular phone of folded type that includes a cover panel and a base panel coupled by a hinge for swiveling of the cover panel between a folded state and an open state. The base panel includes a touch-sensitive panel mounted thereon, whereas the cover panel includes an image projector for projecting an image of keyboard information onto the touch-sensitive panel. The keyboard information includes a label for each of the keypads for designating the function of the keypad. A control unit is also provided for detecting a function specified by an input operation on the front surface of the base panel.

Despite efforts to date, a need remains for systems and methods that render graphical information associated with a control panel, e.g., verbiage and/or icons/symbols, invisible or non-existent until a desired user stimulus. In addition, a need remains for systems/methods wherein the foregoing graphical information is rendered invisible or non-existent until a user moves within a predetermined proximity to the control panel. These and other needs are satisfied by the disclosed systems and methods, as will be apparent to persons skilled in the art from the description which follows.

Systems and methods for projecting graphics onto a surface are provided. According to exemplary embodiments, systems and methods for projecting control graphics onto a surface that includes control functionality are provided. The surface may take the form of a control panel, touch panel or the like. The control panel is typically operatively connected to various components and/or systems, and is typically adapted to control various operations and/or functionalities. The control graphics are generally projected onto the surface, e.g., the control panel or touch panel, in response to a stimulus, e.g., user interaction. In exemplary embodiments, the stimulus/user interaction may take the form of voice command, user proximity (e.g., to a sensor), or the like. Graphic projection onto the surface may vary in intensity (e.g., over a range of dim to bright), and may be undetectable (e.g., non-existent) in the absence of the requisite stimulus. In further exemplary embodiments, information (e.g., programming reminders) or images (e.g., decorative images) may be projected onto the surface in place of control graphics, e.g., in the absence of the requisite stimulus.

According to exemplary embodiments of the present disclosure, the system includes a projection unit, a surface aligned with the projection unit that includes control elements, and a sensing mechanism that is positioned to sense a predefined stimulus. For example, the sensing mechanism may be adapted to sense a user's voice command, the presence of an individual within a predetermined proximity to the surface, or other predefined stimulus. The control elements are generally in electronic communication with associated control systems. Thus, for example, in the case of a television system, a volume control element is generally in electronic communication with volume control circuitry internal to the television system, etc.

In exemplary embodiments of the present disclosure, the projection unit is positioned in an elevated position relative to the control panel surface. In alternative embodiments, the projection unit may be positioned behind or within the control panel surface, e.g., to achieve a “back lit” effect when activated. The projected graphics may take a variety of forms, e.g., verbiage, icons, symbols and/or combinations thereof. The projected graphics may be displayed directly on the responsive portion of the control panel surface, e.g., a touch panel surface, or in close proximation to such responsive portions. The projected graphics may be projected in different colors and at different intensities. For example, the intensity/brightness of the projected graphics may be proportionate to different sensing levels, e.g., a brighter intensity as an individual comes closer to the control panel surface. The projected graphics generally disappear after a predetermined time and/or in response to a terminating action on the part of user, e.g., a voice command and/or actuation of a control element.

The disclosed systems and methods may be advantageously employed in a variety of applications, including consumer applications, industrial applications, medical applications, and the like. Thus, for example, the disclosed projection system for projecting graphical information onto a control panel surface may be used to advantage in medical applications, e.g., in connection with medical equipment requiring periodic user interface (e.g., NMR units, MRI units, X-ray units). Similarly, dentistry applications, optician/optometric applications, and hospital room monitoring equipment may benefit from the disclosed graphical projection systems. Additional applications include kiosk interfaces, manufacturing equipment, residential appliances, and the like.

The disclosed systems/methods offer numerous advantages to system manufacturers and system users. According to exemplary embodiments, the control graphics are not visible unless and until a user causes the projection unit to project the control graphics onto an associated control panel surface. In this way, the control panel surface remains clear and uncluttered by control graphics that are not then-needed. Moreover, the region/surface that includes control elements may be employed in different ways and/or for other purposes up until such time as graphical information is projected thereon, e.g., as part of a visual display that is not cluttered or otherwise obscured by the foregoing graphical information. Indeed, the disclosed projection unit may project first graphical content onto the control surface until such time as the sensing mechanism receives a predetermined stimulus, and second graphical content, e.g., graphical control verbiage, icon(s) and/or symbol(s) in response to the predetermined stimulus.

Additional features and functions associated with the disclosed system/method will become apparent from the detailed description which follows, particularly when read in conjunction with the appended figures.

To assist those of ordinary skill in the art to which the subject matter herein pertains in making and using the disclosed systems and methods, reference is made to the appended figures, wherein:

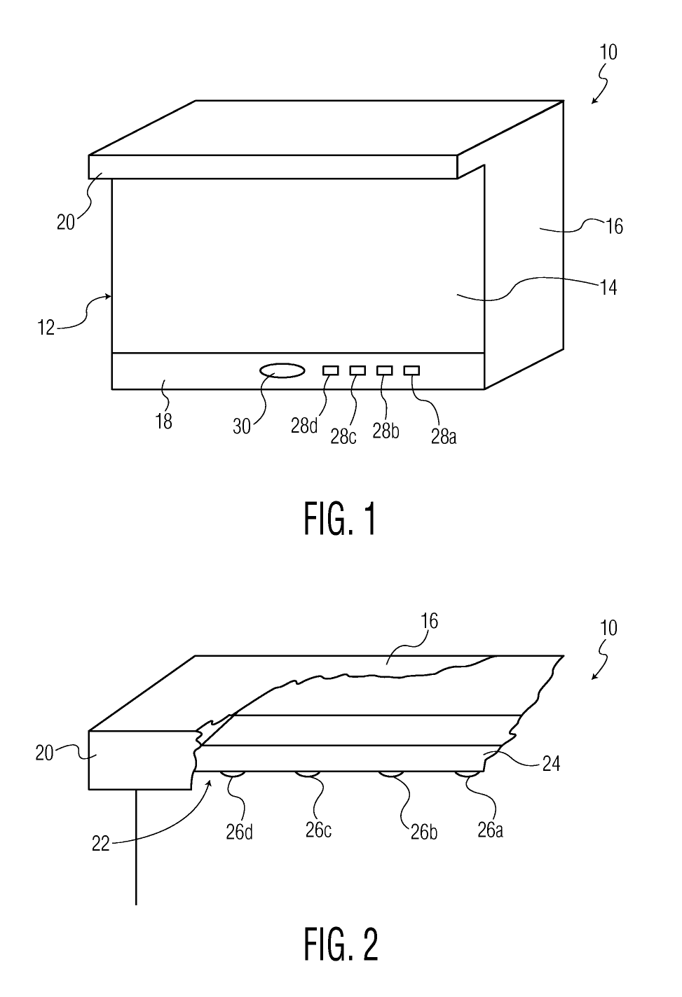

FIG. 1 is a schematic diagram of an exemplary television system according to the present disclosure;

FIG. 2 is a cut-away view of a portion of the exemplary television system of FIG. 1;

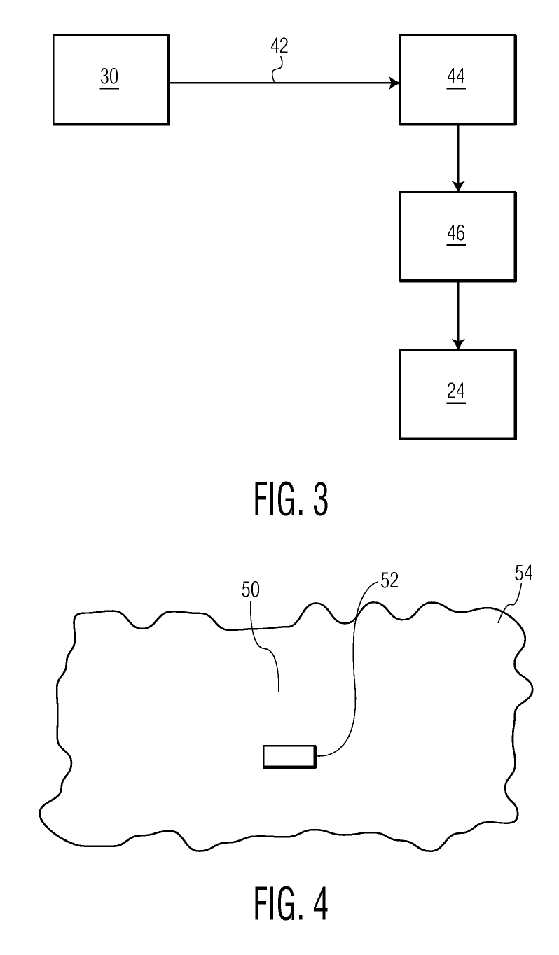

FIG. 3 is a schematic flow sheet/block diagram related to operation of an exemplary embodiment of the present disclosure; and

FIG. 4 is a cut-away view of a portion of the exemplary television system with graphics projected thereon.

The present disclosure provides advantageous systems and methods for projecting graphics onto a control panel surface. Generally, the control surface takes the form of a control panel that is in electronic communication with and/or operatively connected to various components and/or systems of the overall apparatus (e.g., television, computer system, kiosk, equipment, or the like). While it is contemplated that the control panel may be “hard wired” to the associated componentry, it is further contemplated that the control panel (and individual control elements thereof) may communicate with associated componentry through wireless means, e.g., infrared, RF or the like. The control elements of the control panel typically control various features and/or functionalities of the underlying apparatus, and may “toggle” the feature/functionality between “on” and “off” states, or may adjust the level, location and/or magnitude of a feature/functionality, e.g., by varying the volume, intensity, channel or the like.

According to exemplary embodiments of the present disclosure, the system includes a projection unit, a surface aligned with the projection unit that includes control elements, and a sensing mechanism that is positioned to sense a predefined stimulus. For example, the sensing mechanism may be adapted to sense a user's voice command, the presence of an individual within a predetermined proximity to the surface, or other predefined stimulus. Once activated, the projection unit projects control graphics onto or in close proximity to the control panel surface.

Thus, with reference to FIG. 1, an exemplary system 10 according to the present disclosure is schematically depicted. System 10 includes a television console 12 that defines a viewing screen 14, a housing 16 and a control panel 18 below viewing screen 14. Although the control panel 18 is shown at base of television console 12, the present disclosure is not limited to such relative positioning of control panel 18. Rather, control panel 18 may be positioned along the left side of viewing screen 14, along the right side of viewing screen 14, or combinations of such relative positionings. Similarly, the design/geometry of television console 12 and/or viewing screen 14 may be varied without departing from the spirit or scope of the present disclosure, as will be readily apparent to persons skilled in the art.

With further reference to FIG. 1, exemplary system 10 further includes a housing extension 20 that protrudes from housing 16 at an upper region thereof. In the exemplary embodiment of FIG. 1, housing extension 20 is substantially rectangular in geometry and extends across the front face of television console 12. However, alternative housing extension geometries may be employed to achieve desired decorative/visual effects without departing from the present disclosure. For example, the front face 22 of housing extension may be divided into two panels that are angled relative to each other, meeting at a vertical plane at the mid-point of television console 12. Housing extension 20 defines an internal cavity or region 22 within which is positioned a projection unit 24. The projection lens or imaging element(s) of projection unit 24 is/are directed downwardly such that images projected therefrom appear on control panel 18.

Turning to FIG. 2, a cutaway of housing extension 20 is provided so as to provide greater visibility to the internal cavity/region 22 and the exemplary projection unit 24 positioned therewithin. Projection unit 24 includes a plurality of projection lenses/imaging elements 26a-26d which are directed downward toward control panel 18. Although the projection lenses/imaging elements 26a-26d are schematically depicted as distinct elements in FIG. 2, it is to be understood that the present disclosure is susceptible to a variety of implementations and designs. Thus, for example, the imaging surface of projection unit 24 may take the form of a continuous (i.e., uninterrupted) imaging element that is adapted to project distinct graphical images onto control panel 18. The design and operation of projection units is well within the skill of persons in the imaging field and, based on the present disclosure, selection and deployment of appropriate projection unit(s) 24 is readily achieved.

With further reference to FIGS. 1 and 2, projections lenses/imaging elements 26a-26d are configured and aligned to project graphical images toward control panel 18 such that: (i) the image projected from imaging element 26a is aligned with and/or overlaid (in whole or in part) on control element 28a, (ii) the image projected from imaging element 26b is aligned with and/or overlaid (in whole or in part) control element 28b, and so on. The projected image may take the form of graphical verbiage (in various languages), icons and/or symbols. Of note, the ability to project graphical verbiage in an appropriate national language by making appropriate software and/or processing changes with respect to the driver for projection unit 24 facilitates advantageous manufacturing and inventory management results.

As schematically depicted in FIG. 1, television console 12 also includes one or more sensing mechanisms 30 which is/are directed outward from television console 12. In the exemplary embodiment of FIG. 1, sensing mechanism 30 is a “motion sensor” that is adapted to detect motion within a predetermined distance relative to television console 12. Thus, in exemplary embodiments of the present disclosure, motion within a predetermined distance of three feet (or less) is sensed by sensing mechanism, causing activation of projection unit 24 (as described below). Different activation distances may be employed without departing from the spirit or scope of the present disclosure. Indeed, it is contemplated that system 10 may be designed/implemented such that the sensing distance may be adjusted by an end user, such that activation performance of the disclosed system may be adjusted/customized to a particular location of use. A desired adjustment in operation of sensing mechanism 30 may be implemented in various ways, e.g., modifying the angle of sensing mechanism 30 relative to the horizontal plane (i.e., the floor).

It is noted that sensing mechanisms according to the present disclosure are not limited to motion sensors as described with reference to exemplary system 10 herein. Rather, alternative sensing mechanisms may be employed, e.g., voice recognition sensors, without departing from the spirit or scope of the present disclosure. Indeed, multiple sensing mechanisms may be mounted with respect to television console 12, each sensing mechanism being responsive to a different stimulus, so as to further enhance the responsiveness and/or flexibility of the disclosed systems/methods. Thus, in exemplary embodiments, the stimulus/user interaction may take the form of voice command, user proximity to the sensing mechanism, or the like.

Turning to FIG. 3, a schematic depiction of control system 40 is provided. Control system 40 includes a processor 44 that is responsive to a signal 42 received from sensing mechanism 30. Signal 42 may be transmitted to processor 44 across internal wiring/fiber or through appropriate wireless technology. Processor 44 is in communication with one or more drivers 46 which provide input to projection unit 24. Of note, driver(s) 46 may take the form of software that operates on processor 44 but, for illustrative purposes, driver 46 is depicted as a separate component in the diagram of FIG. 3.

According to exemplary embodiments of the present disclosure, the graphic projection onto control surface 18 may vary in intensity (e.g., over a range of dim to bright) based on the input provided by processor 44 and/or driver 46, e.g., based on a system user's proximity and/or the command(s) provided to a voice recognition sensor. However, according to exemplary embodiments of the present disclosure, processor 44 receives a modified signal 42 from sensing mechanism 30 when the predetermined stimulus is discontinued, e.g., the user moves outside/beyond the predetermined distance. In such circumstance, the processor 44 may be adapted to deactivate projection unit 24 immediately, or commence a timer sequence that will cause projection unit 24 to be deactivated after a predetermined period.

An exemplary projected image 50 adjacent a control element 52 on a control surface 54 is provided in FIG. 4. The projected image takes the form of verbiage, although icons and/or symbols may also be employed (alone or in combination) as described herein. Additional control elements (not pictured) are typically positioned on control surface 54 and appropriate projected images are generally displayed on or adjacent to such additional control elements (or a combination thereof).

Operating details of exemplary embodiments of the disclosed system/method are typically embodied in software/programming that operates/runs on processor 44 and/or driver(s) 46. For example, processor 44 of the disclosed system/method may be programmed so as to project ancillary information (e.g., programming reminders) or images (e.g., decorative images) onto the control surface in place of control graphics, e.g., in the absence of the requisite stimulus.

Thus, the present disclosure provides a projection unit that is positioned in an elevated position relative to a control panel surface. In alternative embodiments, the projection unit may be positioned behind or within the control panel surface, e.g., to achieve a “back lit” effect when activated. As noted herein, the projected graphics may take a variety of forms, e.g., verbiage, icons, symbols and/or combinations thereof. The projected graphics may be displayed directly on the responsive portion of the control panel surface, e.g., a touch panel surface, or in close proximation to such responsive portions. The projected graphics may be projected in different colors and at different intensities. For example, the intensity/brightness of the projected graphics may be proportionate to different sensing levels, e.g., a brighter intensity as an individual comes closer to the control panel surface. The projected graphics generally disappear after a predetermined time and/or in response to a terminating action on the part of user, e.g., a voice command and/or actuation of a control element.

As noted above, the disclosed systems and methods may be advantageously employed in a variety of applications, including consumer applications, industrial applications, medical applications, and the like. Thus, for example, the disclosed projection system for projecting graphical information onto a control panel surface may be used to advantage in medical applications, e.g., in connection with medical equipment requiring periodic user interface (e.g., NMR units, MRI units, X-ray units). Similarly, dentistry applications, optician/optometric applications, and hospital room monitoring equipment may benefit from the disclosed graphical projection systems. Additional applications include kiosk interfaces, manufacturing equipment, residential appliances, and the like.

The disclosed systems/methods offer numerous advantages to system manufacturers and system users. According to exemplary embodiments, the control graphics are not visible unless and until a user causes the projection unit to project the control graphics onto an associated control panel surface. In this way, the control panel surface remains clear and uncluttered by control graphics that are not then-needed. Moreover, the region/surface that includes control elements may be employed in different ways and/or for other purposes up until such time as graphical information is projected thereon, e.g., as part of a visual display that is not cluttered or otherwise obscured by the foregoing graphical information. Indeed, the disclosed projection unit may project first graphical content onto the control surface until such time as the sensing mechanism receives a predetermined stimulus, and second graphical content, e.g., graphical control verbiage, icon(s) and/or symbol(s) in response to the predetermined stimulus.

Although the present disclosure has been described with reference to exemplary embodiments and/or applications of the advantageous projection system of the present invention, the present disclosure is not limited to such exemplary embodiments and/or applications. Rather, the systems and methods disclosed herein are susceptible to many variations and modifications without departing from the spirit or scope of the present invention. For example, the projected graphics may be projected at varying levels of intensity (e.g., dim, bright, etc.) based on predetermined factors, e.g., the proximity of a user, time period since the last user interaction, user preference, or the like. Similarly, projected graphics may be used to supply ancillary information to a system user (e.g., program reminders) based on user-selected criteria. Thus, as will be readily apparent to persons skilled in the art, the disclosed systems and methods may be enhanced, modified and/or varied without departing from the spirit or scope of the present invention.

1. A system for projecting graphics onto a surface, comprising:
a. a projection unit;
b. a surface positioned to receive a projected image from said projection unit; and
c. a sensing mechanism for sensing a predetermined stimulus, the sensing mechanism being adapted to cause a control signal to be transmitted to the projection unit.

2. A system according to claim 1, further comprising a processor that is programmed to receive a signal from the sensing mechanism and, based on predetermined criteria, to generate one or more control signals for transmission to the projection unit.

3. A system according to any of the preceding claims, wherein the projection unit is positioned above the surface.

4. A system according to any of the preceding claims, wherein the projection unit includes a plurality of projecting elements.

5. A system according to any of the preceding claims, wherein the surface is a control panel that includes one or more control elements.

6. A system according to any of the preceding claims, wherein the surface is a control panel for a television unit, and wherein the control panel includes a plurality of control elements for control of functions associated with the television unit.

7. A system according to any of the preceding claims, wherein the sensing mechanism is mounted with respect to a console, and the sensing mechanism is adapted to sense the presence of a user within a predetermined distance of the console.

8. A system according to any of the preceding claims, wherein the projected image is selected from the group consisting of verbiage, icons, symbols and combinations thereof.

9. A system according to any of the preceding claims, wherein the projected image is projected a varying intensity level based on predetermined intensity criteria.

10. A system according to any of the preceding claims, wherein the surface is associated with a piece of equipment.

11. A system according to claim 10, wherein the piece of equipment is a television unit, a piece of medical equipment, a consumer electronic, an appliance, or another piece of equipment that includes one or more control elements.

12. A system according to any of the preceding claims, wherein the sensing mechanism is responsive to voice commands.

13. A method for controlling projected images, comprising:
a. providing a unit that includes a projection unit, a surface for receiving a projected image, and a sensing mechanism that communicates (directly or indirectly) with the projection unit;
b. supplying a stimulus to said sensing mechanism; and
c. permitting said sensing mechanism to cause a control signal to be generates for transmission to the projection unit.

14. A method according to claim 13, wherein the projection unit generates one or more images for projection onto the surface in response to the control signal.

15. A method according to any of the preceding method claims, wherein the projection unit is adapted to generate images that are selected from verbiage, icons, symbols and combinations thereof.

16. A method according to any of the preceding method claims, wherein the stimulus is in response to proximity of a system user.

17. A method according to any of the preceding method claims, wherein the stimulus is a voice command.
